(19) United States
(12) Patent Application Publication
(10) Pub. No.: US 2025/0200205 A1
(43) Pub. Date: Jun. 19, 2025

(54) DISTRIBUTED DYNAMIC MULTI-LEVEL SECURITY DATA

(71) Applicants: Vincent E. Fogle, JR., Venice, FL (US); Karen L. Trapane, St Petersburg, FL (US); Gleen K. M. Char, Parker, CO (US); Ledford J. Meadows, III, Tarpon Springs, FL (US); Nicholas J. Leon, Gibsonton, FL (US)

(72) Inventors: Vincent E. Fogle, JR., Venice, FL (US); Karen L. Trapane, St Petersburg, FL (US); Gleen K. M. Char, Parker, CO (US); Ledford J. Meadows, III, Tarpon Springs, FL (US); Nicholas J. Leon, Gibsonton, FL (US)

(21) Appl. No.: 18/543,560

(22) Filed: Dec. 18, 2023

(51) Int. Cl. G06F 21/62

(52) U.S. Cl. CPC G06F 21/6218

(57) ABSTRACT

Systems, devices, methods, and computer-readable media for multi-level security (MILS) data collaboration and access. A method includes receiving new data to be stored in a knowledge repository, the new data generated based on prior data accessed through a data fabric, determining a classification of a hierarchy of classifications for the new data, storing the classification as metadata associated with the new data in the knowledge repository and the new data via the data fabric, receiving a request from a user to access first data via the data fabric, determining, based on defined subject attributes, a global access policy, object attributes, a classification of the first data, and attributes of the user, that the user is authorized to access the first data, and providing the first data to the user.

### TECHNICAL FIELD

Embodiments regard seamless information exploration, extraction, and exchange. Embodiments provide an ability to gain higher knowledge through multi-level data search, linking, and access across multiple domains while ensuring trusted data governance, provenance, and protection.

### BACKGROUND

Many entities have large amounts of data, more than petabytes of data in some instances. For example, each day, about 2.5 quintillion bytes of data are generated by the United States military alone. Due to the scope of the data, the entities do not know the content of all the data. The lack of knowledge regarding the content of the data makes it hard, if not impossible, to organize and use the data. The entity data resides in multiple domains, sometimes called “communities of interest” (COIs). Due to accreditation boundaries and classification of systems, the entities (i.e., consumers) are restricted from exploiting the data using search, selection, analytics, or the like and gaining access to potential valuable information (i.e., higher knowledge). Current technology for data tagging and release is limited by file format, cumbersome, and flawed review cycles and requires a lot of human intervention.

### BRIEF DESCRIPTION OF DRAWINGS

FIG. 1 illustrates, by way of example, a diagram of an embodiment of a system that includes Multi-Level Security (MLS) data access and provisioning.

FIG. 2 illustrates, by way of example, a diagram of an embodiment of a system for secure MLS data access.

FIG. 3 illustrates, by way of example, a diagram of an embodiment of a system for secure MLS data access.

FIG. 4 illustrates, by way of example, a diagram of an embodiment of the AI/ML policy engine and corresponding inputs and outputs.

FIG. 5 illustrates, by way of example, a diagram of an embodiment of the MLS knowledge repository.

FIG. 6 illustrates, by way of example, a diagram of an embodiment of a portion of the MLS security services.

FIG. 7 illustrates, by way of example, a diagram of an embodiment of a method for secure MLS data access and collaboration.

FIG. 8 is a block diagram of an example of an environment including a system for neural network (NN) training.

FIG. 9 illustrates, by way of example, a block diagram of an embodiment of a machine in the example form of a computer system within which instructions, for causing the machine to perform any one or more of the methods or techniques discussed herein, may be executed.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

Cooperating entities, entities that work together to achieve a common goal, can benefit from rapid and seamless information exploration and exchange of data across various domains and classification levels. Domains are different repositories of data and classifications indicate data sensitivity. Example classifications include unclassified, classified, secret, top secret, etc. Some classifications can be user-dependent. User-dependent classifications indicate which users are authorized to access the data.

Embodiments provide a multi-function capability that supports secure multi-level data access across data fabrics spanning multiple accreditation boundaries. Embodiments provide one or more of (i) a unique overall solution that supports higher knowledge/analytics through near-real time MLS data access and dissemination (creates an MILS system where there was none); (ii) an MLS knowledge repository that is a unique environment created based on file integrity binding to a certificate and software defined network (SDN) techniques to separate data based on classification; (iii) an attribute based access control (ABAC) file or object modifier that includes an artificial intelligence (AI)/machine learning (ML) based augmentation of structured and unstructured data to append attributes, tags, and certificate, to nonstandard file or object types (e.g., tactical, mission data/file/object types); or (iv) an AI/ML policy engine that provides an AI/ML assignment of classification level based on security classification guides/policies.

Embodiments provide a capability that supports secure multi-level data access across data fabrics spanning multiple, sometimes numerous, accreditation boundaries. Embodiments can leverage common data fabrics that normalize file formats across multiple consumers being employed within classified communities. Embodiments can augment the common data fabric to support MLS data object collaboration and use by consumers across these multiple operational domains. Embodiments can inspect classification markings and tag data according to policy. Based on need-to-know (NTK), embodiments can provide consumers an ability to securely search, select, and perform analytics across the multiple operational domains to obtain higher knowledge. Embodiments can store higher knowledge data (i.e., analytics) in alignment with a defined policy.

Embodiments provide technologies and procedures to develop an MLS aware environment that supports gaining of higher knowledge through MLS search, access, labeling, and data dissemination. Embodiments can use existing accredited systems. Embodiments can integrate an MLS system through the MLS knowledge repository. Embodiments can use AI/ML to remove a human in the loop. The AI/ML can be used for inspection of classified data in real time through an ABAC Boolean union modifier. Embodiments can use an AI/ML policy engine to increase quantification of classification levels.

Prior systems, such as single classification systems, have technical limitations that are overcome by the embodiments herein. Overcoming these technical limitations requires technical and process paradigm shifts provided by embodiments. Embodiments support reuse of customer resources with minimal impact to host system accreditation. Embodiments prevent east-to-west data movement within the hardware stack (i.e., prevents lateral data movement) thus providing improved security.

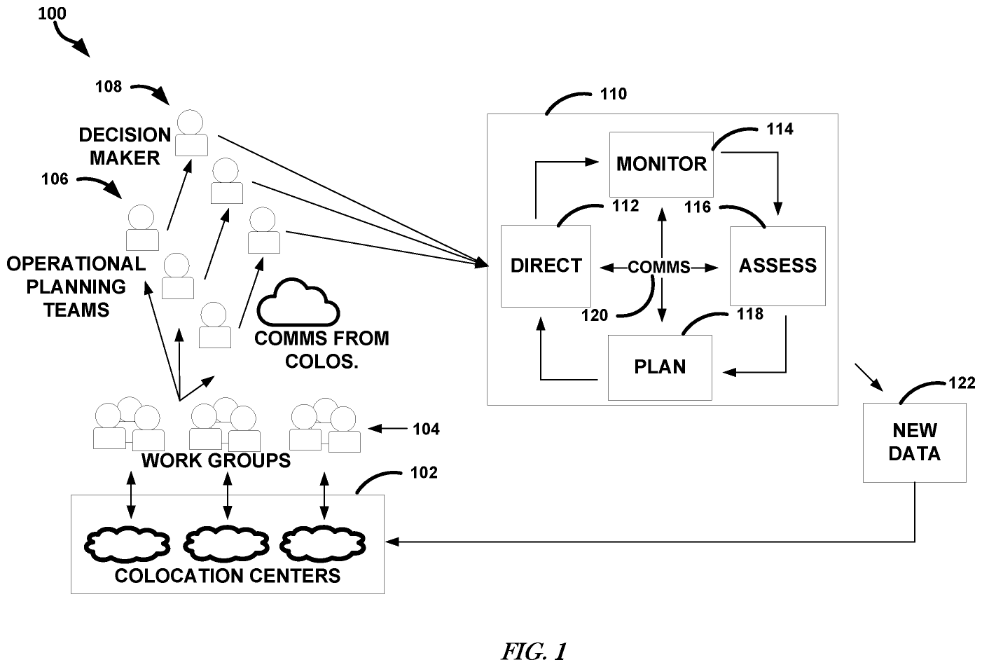

FIG. 1 illustrates, by way of example, a diagram of an embodiment of a system 100 that includes MILS data access and provisioning. The system 100 as illustrated includes individuals, groups, or a combination thereof (called “personnel” herein), working together to achieve a common goal. The goal, in some instances, can be for command and control (C2), such as for military applications. The personnel illustrated include work groups 104, operational planning teams 106, and decision makers 108. The work groups 104 operate on data from various colocation centers 102. The colocation centers 102 can store data classified in one or more of a variety of classification levels. A given document can be classified in one or more classification levels. Different portions of a same document can have different classifications, for example. The work groups 104 can perform analytics on the data from the colocation centers 102. The results of the analytics, the data used to generate the analytics, supporting documentation for the analytics or the data, or the like can be provided to operational planning teams 106. The work groups 104 can store results of their analysis in the colocation centers 102.

The operational planning teams 106 operate on the data used by the work groups 104 and generated by the work groups 104. The operational planning teams 106 can access the colocation centers 102, such as to request the data and store their plans or recommendations for access by the decision maker 108.

The decision maker 108 is ultimately responsible for selecting a plan 118 and directing 112 personnel or resources based on the plan 118. The plan 118 is selected, by the decision maker 108, based on the recommendations or plan from the operational planning teams 106.

Personnel or devices can monitor 114 and assess 116 the plan 118 as it is being implemented. The results from the monitoring 114 and assessment 116 can result in new data 122 being provided to the colocation center 102. The working groups 104 can consider the new data in their analysis and the process can repeat up through the decision maker 108. Throughout the process, personnel communicate 120 to plan 118, direct 112, monitor 114, and assess 116 with the goal in mind.

Issues encountered with this scenario include: ensuring that each level of the personnel, from the work groups 104 to the operational planning teams 106 and up to the decision maker 108, has access to the data required to perform their duties; ensuring that the results of the analyses conducted by the work groups 104, operational planning teams 106, and decision maker 108 are available to the personnel who are going to rely on them; and classifying the results of the analyses in a way that is not time consuming, is accurate, and ensures access by personnel that will rely on the analyses to perform their duties, among others.

Embodiments help overcome one or more of these issues, such as by leveraging AI/ML for classification and tagging of data. The tagging can be used by the classification system to determine a classification. The tagging can be used by a certificate authority or amended by a certificate authority. The tagging can help indicate provenance and integrity of the data of a file/object. Embodiments help overcome one or more of these issues, such as by using ABAC instead of origin-based authorization.

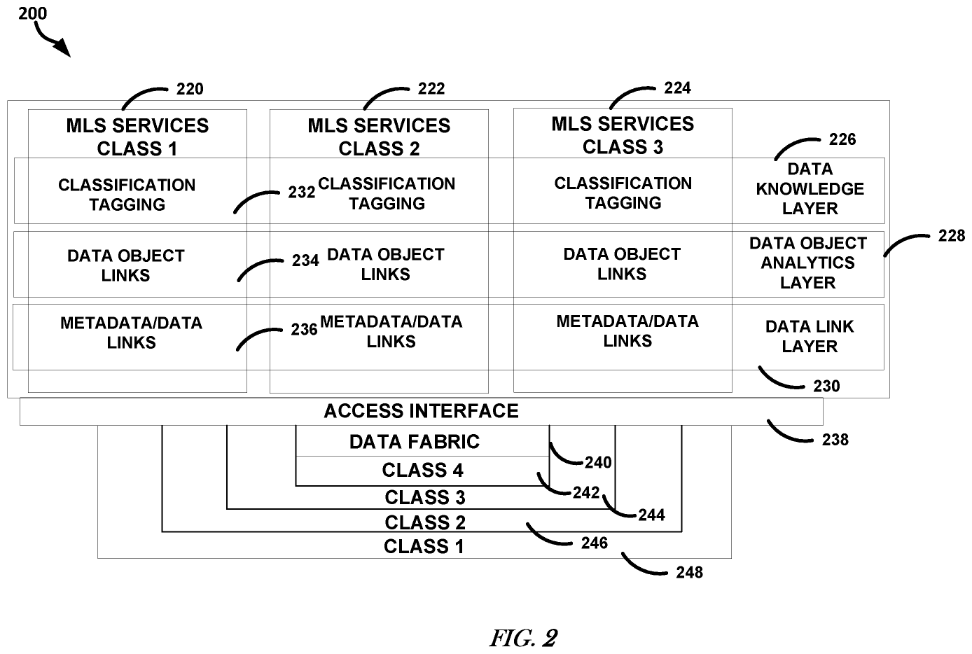

FIG. 2 illustrates, by way of example, a diagram of an embodiment of a system 200 for secure MLS data access. The system 200 as illustrated includes multiple MLS services 220, 222, 224. The MLS services 220, 222, 224 are accessible through an access interface 238. The access interface 238 interfaces between a data fabric 240 and the MLS services 220, 222, 224. The access interface 238 can include cross domain solutions (CDSs). CDSs are forms of controlled interfaces. A controlled interface is a boundary with a set of mechanisms that enforces the security policies and controls the flow of information between interconnected information systems. The CDS provides the ability to manually or automatically access or transfer information between different security domains. Different security domains include different classification tiers, such as classified, unclassified, etc.

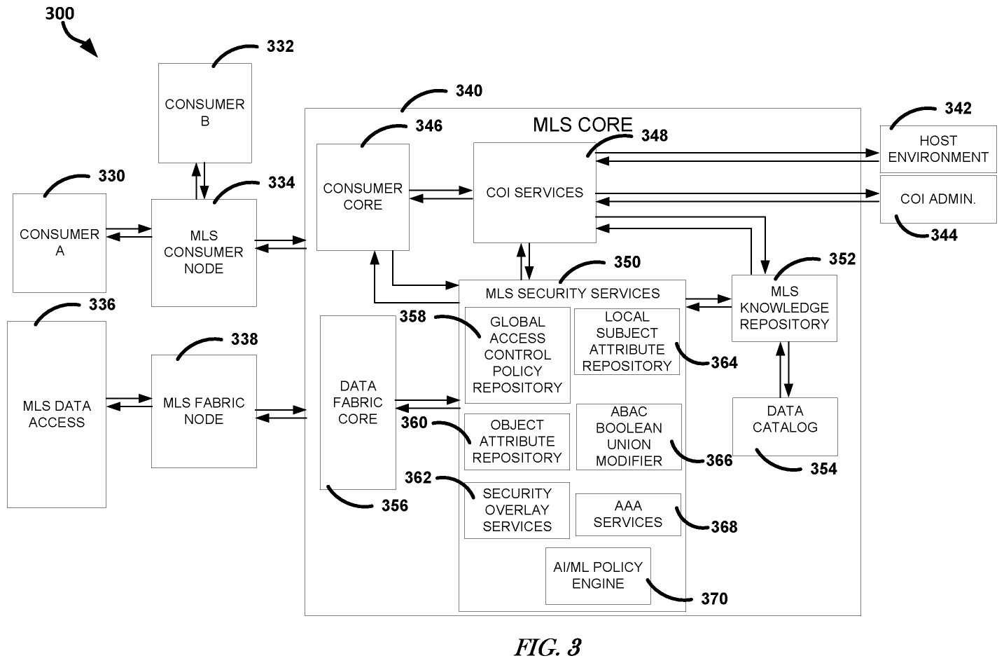

The MLS services 220, 222, 224 include layers 226, 228, and 230. A data knowledge layer 226 understands the contents of data, such as through metadata. The data knowledge layer 226 is responsible for performing a classification tagging operation 232. The operation 232 includes, determining, based on metadata, contents of the data, or a combination thereof, a classification of data to be stored in a knowledge repository 352 (see FIG. 3 among others) by way of the data fabric 240. The operation 232 can be performed using an ML model. The data knowledge layer 226 allows a user to access at least a subset of the data accessible through the data fabric 240.

A data object analytics layer 228 is responsible for performing a data object links operation 234 that relates data analytics with the data that was used to generate the analytics. The results of the analytics can be associated with the data used to generate the analytics by metadata that is associated with the analytics. The metadata can include data that uniquely represents the data that was used to generate the analytics. The data object analytics layer 228 is responsible to for selecting a data object from the fabric 240.

A data link layer 230 is responsible for performing a metadata/data link operation 236. The metadata/data link operation 236 associates data paths with the data and metadata associated with a file. The links provided by the operation 236 can be automatically loaded or user-selectable. Responsive to a user selecting the link, the file associated with the link can be retrieved and presented to the user. The data link layer 230 provides a federated search functionality to a user. The federated search allows for searching of multiple data sources (e.g., colocation centers) at once.

The data fabric 240 couples multiple colocation centers. The data fabric 240 includes access to data in multiple classification tiers 242, 244, 246, 248. The tiers 242, 244, 246, 248 can be in a hierarchy. A hierarchy of classification tiers means that an entity authorized to access data of a higher classification tier is allowed to access data of any tier below the higher classification tier. For example, an entity that is authorized to access data classified as top secret can access any data classified as top secret, secret, confidential, unclassified, or a combination thereof.

The MLS services 220, 222, 224 can be dedicated to servicing data of one or more of the classifications. For example, the services 220 can be dedicated to servicing only unclassified and classified data, while the services 222 can be dedicated to servicing unclassified, classified, and secret data and the services 224 can be dedicated to servicing all classifications of the data. Each of the services 220, 222, 224 is responsible for authenticating a user prior to servicing a request for a data write or a data read to the fabric 240.

FIG. 3 illustrates, by way of example, a diagram of an embodiment of a system 300 for secure MLS data access. The system 300 as illustrated includes consumers 330, 332 that access functionality of an MLS core 340 through an MLS consumer node 334. A community of interest administrator 344 manages the operations of the MLS core 340. A host environment 342 is a physical environment that hosts services of the MLS core 340. An MLS data access 336 node 336 provides data through the data fabric 240 to an MLS fabric node 338. The MLS fabric node 338 interfaces between the MLS data access node 336 and the MLS core 340.

The consumers 330, 332 are work groups 104 who have compute devices that communicate with the MLS consumer node for access to the data of the fabric 240. The consumers 330, 332 can employ computers, appliances, smart devices, or the like.

The MLS consumer node 334 provides the interface through which the consumers 330, 332 access data through the data fabric 240. The consumers 330, 332 provide credentials and other input to the MLS consumer node 334. The MLS consumer node 334 issues policy requests, provides a browser screen, and analytics data to the consumers 330, 332 if the user has valid credentials.

The MLS consumer node 334 can provide a secure peer-to-peer communication channel, such as over a secure socket layer (SSL) channel. The MLS consumer node 334 can provide a simple storage service (S3) compliant application programming interface (API). The MLS consumer node 334 can provide a single sign-on (SSO) service for consumer 330, 332 access. The MLS consumer node 334 can include a data exchange controller. The data exchange controller acts like a proxy server, opening a secured connection with—and only with—the data to be accessed, thanks to the use of unique data product identifications.

The MLS consumer node 334 provides analytics results to the MLS core 340. The MLS core 340 provides policy requests (credentials), data links (e.g., references or pointers), and data accessible through the MLS fabric data 240 to the MLS consumer node 334.

The MLS data access 336 indicates, to the MLS fabric node 338, what classes of data are accessible through the data fabric 240. The MLS data access 336 receives a request for system credentials or fabric data from the MLS fabric node 338.

The MLS fabric node 338 provides data links and fabric data to the MLS core 340. The MLS fabric node 338 receive policy requests for system credentials, data, or a combination thereof from the MLS fabric node 338. The MLS fabric node 338, the MLS data access 336, and the MLS core, can, in combination perform the operations of the system 200.

The MLS fabric node 338 can include a peer-to-peer communication channel, an S3 compliant API, a data exchange controller, or a combination thereof.

The MLS core 340 includes a consumer core 346 communicatively coupled to COI services 348, and MLS security services 350. The COI services 348 are communicatively coupled to the host environment 342, the COI administrator 344, and the MLS security services 350. The MLS security services 350 are communicatively coupled to the consumer core 346, COI services 348, data fabric core 356, and MLS knowledge repository 352. The data catalog 354 is communicatively coupled to the MLS knowledge repository 352.

The consumer core 346 can include a peer-to-peer communication channel, an S3 compliant API, a data exchange controller, or a combination thereof. The consumer core 346 can issue status logs to the COI services 348. The COI services 348 can provide service creation and management for the consumer core 346. The consumer core 346 can provide consumer data for review and marking to the MLS security services 350. The consumer core 346 provides a data request to the MLS security services 350. The consumer core 346 can receive MLS security services controlled data from the MLS security services 350.

The COI services 348 can provide services, such as virtualization, directory services, container services, certificate authority (CA), logging services, and automation services. The host environment 342 provides the hardware needed for operation of the COI services 348. The COI administration 344 issues policy requests to the COI services 348. The COI services 348 indicates policies and configurations to the COI administration 344.

The COI services 348 provides management service for the MLS knowledge repository 352. The COI services 348 receives service logs from the MLS knowledge repository 352. The COI services provides management for the MLS security services 350. The MLS security services 350 provides status logs to the COI services 348.

The MLS knowledge repository 352 receives object attributes from the MLS security services 350. The MLS knowledge repository 352 provides role based access control (RBAC) or attribute based ABAC requests to the MLS security services 350. The MLS knowledge repository 352 provides labeled files or data objects to the MLS security services 350. The MLS knowledge repository 352 provides object attributes to the data catalog 354. The data catalog 354 provides metadata or data object links to the MLS knowledge repository 352. The knowledge repository 352 can use micro-segmentation, encryption at rest and in transit to isolate and secure data. New is stored in the knowledge repository 352.

The data catalog 354 includes metadata links and data object links stored thereon. The links in the data catalog 354 can be from the data object analytics layer 228 and the data link layer 230. The data fabric core 356 provides data links or pointers to the MLS security services 350. The data fabric core 356 provides fabric data for review and marking to the MLS security services 350. The MLS security services 350 provides policy requests to the data fabric core 356.

The data fabric core 356 can include a peer-to-peer communication channel, an S3 compliant API, a data exchange controller, a data storage layer, or a combination thereof.

The MLS security services 350 provides security services for the data fabric 240. The security services can include a global access control policy repository 358, an object attribute repository 360, security overlay services 362, local subject attribute repository 364, an ABAC Boolean union modifier 366, authentication, authorization, and accounting (AAA) services 368, and an AI/ML policy engine 370. The global access control policy repository 358 provides credential requirements for any entity to access data accessible through the data fabric 240. The local attribute repository 364 provides attributes for data. The object attribute repository 360 indicates attributes of objects that are accessible through the data fabric 240. The global access control policy repository 358 contains the course grained governance for entity access (user, application) at the enterprise level. This may include authorized users, authorized roles, authorized applications. The object attribute repository 360 contains specific attributes that are assigned to an object, which is a file or piece of data. Attributes may describe classification, data type, location, other identifiers to help define the object. The local subject attribute repository 364 contains attributes at the mission level such as a COI, a specific mission, or time window.

The ABAC Boolean union modifier 366 provides MLS awareness through the intersection of the global access control policy 662 (e.g., authorized user, authorized role) as compared to the local subject attributes 660 and object attributes 664 (e.g., environmental factors 672 such as data classification and its origin). The ABAC Boolean union modifier 366 then uses this intersection to compare the user request 670 to the data markings within the MLS knowledge repository 352 to approve or deny the request (i.e., allow access to the data).

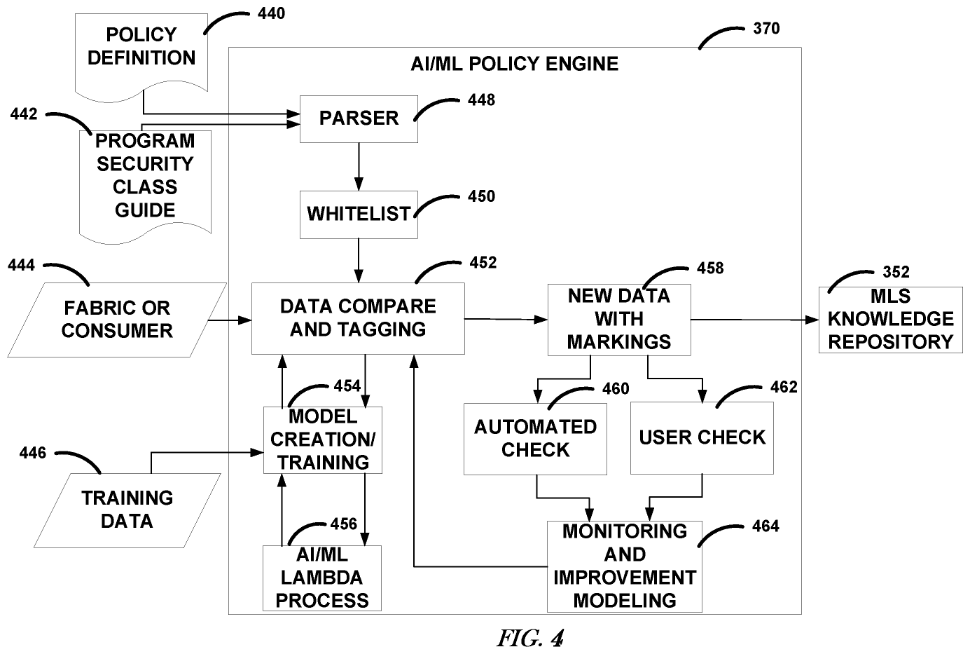

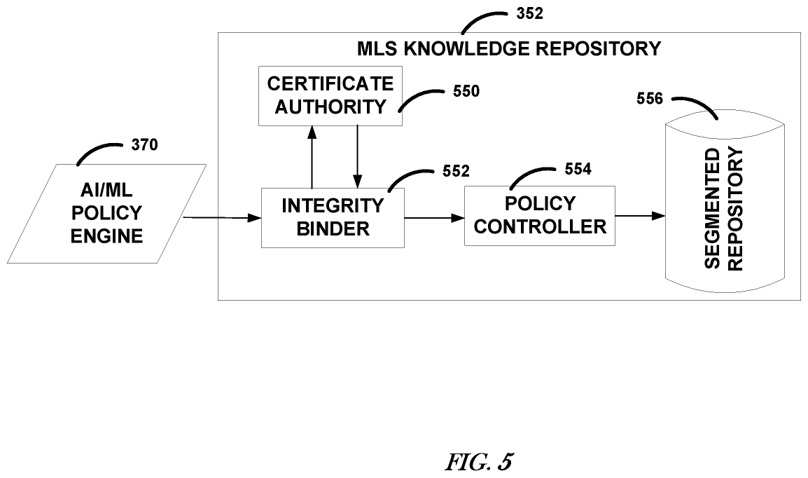

The security overlay services 362 provides access to legitimate users to access the data fabric 240 while protecting from certain cyberattacks, such as denial of service (DoS) attacks. AAA services 368 is a security framework that controls access to computer resources, enforces policies, and audits usage. The AI/ML policy engine 370 is trained to mark new files or objects to be stored in the knowledge repository 352. More details regarding the MLS Knowledge repository 352, ABAC Boolean union modifier 366, and AI/ML policy engine 370 are provided in FIGS. 4-6.

FIG. 4 illustrates, by way of example, a diagram of an embodiment of the AI/ML policy engine 370 and corresponding inputs and outputs. The AI/ML policy engine 370 is responsible for marking data with a classification. The AI/ML policy engine 370 operates based on a policy definition 440, a program security class guide 442, and a request from the fabric 240 or a consumer 330, 332.

The policy definition 440 can include DD form 254 documents. The DD form 254 documents specify classification requirements for classification level safeguarding requirements, access requirements, and performance requirements for a given contract and corresponding data.

The program security class guide 442 indicates specific information and corresponding classification level for the specific information. The specific information can be per program, keyword, idea, object, personnel, or the like.

The request 444 can indicate new data to be stored in the knowledge repository 352 that is to be associated with a classification. The request 444 can provide the data or a location of the data, data that was used to generate the data to be stored, an entity that operated on the data, or the like. The data in the request 444 can be formatted, unformatted, structured, unstructured, or the like. The data in the request 444 can include text files, graphics, source code, emails, streaming data, or the like.

The training data 446 includes input/output examples of data and corresponding classifications. The training data 446 is used by the AI/ML policy engine 370 for determining parameters of an AI/ML model that is going to determine a classification for the data in the request 444.

The AI/ML policy engine 370 uses a parser 448 to identify relevant guidelines for classifying data. The parser 448 determines the relevant guidelines based on the policy definition 440 and the program security classification guide 442. The parser 448 identifies which classifications and data are safe to access and provides the corresponding classifications and data that are safe to the whitelist 450. The whitelist (or allowlist) is like that for a firewall policy with pre-approved attributes for access to data. This may include source or destination Internet Protocol (IP) address, protocols, metadata (date created, author, source), service, or global positioning service (GPS) data.

A data compare and tagging model 452 can operate on data from the request 444 to determine a classification for the data. The data compare and tagging model 452 can operate based on the information in the whitelist 450 and compare to the data from the request 444. The model 452 can be trained, at training operation 454, based on the training data 446. The model 452 can be optimized, through operation 454, to accurately determine a classification for the data in the request 444.

An AI/ML Lambda process 456 is used to deploy the model 452 as a Lambda function. Note other processes are possible, the Lambda process 456 is just an example of deploying the model 452 for access through the cloud.

The model 452 generates new data with markings 458. If the model 452 is sufficiently accurate, feedback and improvement may not be necessary. As illustrated, a feedback and improvement loop is illustrated. The feedback and improvement loop includes an automated check 460, a user check 462, and a monitoring and improvement modeling operation 464. The automated check 460 can include a heuristic check to make sure that the new markings pass a basic check. For example, if the data used to generate the data in the request 444 is classified as secret, and the data in the request is marked as top secret, the automated check 460 can flag the marking as potentially incorrect. The user check 462 can include a human-in-the-loop reviewing results from the model 452 to flag potentially incorrect markings. The operation 464 can generate further training data 446 that can be used to fine tune the model 452. The further training data 446 can include data that was misclassified by the model 452 but with a proper, correct classification.

The new data with markings 458 can be stored in the MLS knowledge repository 352. The classification for the data can be stored in the MLS knowledge repository 352.

The MLS knowledge repository 352 can include a certificate authority 550, an integrity binder 552, a policy controller 554, and a segmented repository 556. The MLS knowledge repository 352 receives marked data 458 from the AI/ML policy engine 370. The integrity binder 552 operates based on the marked data 458 and a certificate from the certificate authority 550. The integrity binder 552 binds a certificate or a hash from the certificate authority 550 to a given file. The integrity binder 552 can use a hardware encryption module, such as a trusted platform module (TPM) to perform the binding.

The certificate authority 550 generates a hash or other type of certificate that allows for safe transfer of information across network boundaries. Certificates are commonly used by web browsers and other applications.

The policy controller 554 directs files or data objects, such as to correct classifications from the AI/ML policy engine 370. The policy controller 554 is a final classification check for the marked data 458.

A segmented repository 556 stores the classification, certificate, binding, new data, or a combination thereof. The segmented repository 556 can include a virtualized environment that stores data based on classification. Data of different classifications can be stored in different segments of the segmented repository 556.

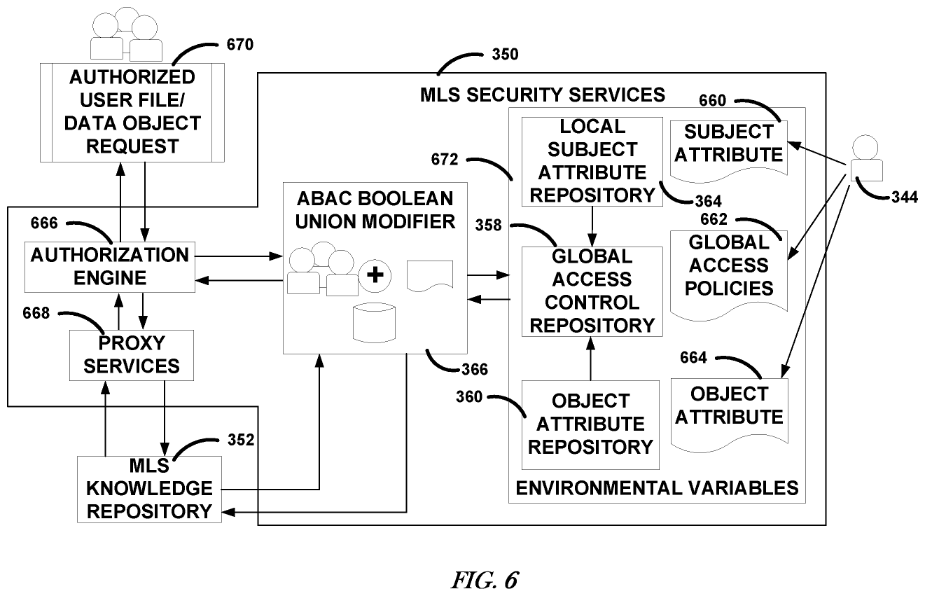

FIG. 6 illustrates, by way of example, a diagram of an embodiment of a portion of the MLS security services 350. A user can issue a request 670 for data from the data fabric 240. An authorization engine 666 can retrieve or request credentials of the user requesting access. The authorization engine 666 issues a query to the ABAC Boolean union modifier 366. In turn, the ABAC Boolean union modifier 366 queries environmental variables 672 for policy considerations relevant to the request 670. The policy considerations can include a subject attribute 660 (e.g., an attribute of the user that issued the request 670), a global access policy 662 (e.g., a requirement for accessing data of the given classification associated with the data that is the subject of the request 670), an object attribute 664 (e.g., a requirement specific to the file or object that is the subject of the request 670), or a combination thereof.

The ABAC union modifier 366 determines, based on the relevant attributes and policies, which attributes or policies need to be satisfied for accessing the data that is the subject of the request 670. The ABAC Boolean union modifier 366 can store the relevant policy considerations and attributes in the MLS knowledge repository 352. The ABAC Boolean union modifier 366 can identify a classification for the data that is the subject of the request 670 by querying the MLS knowledge repository 352.

The proxy services 668 is the gateway between the users and resources. It is a firewall preventing unauthorized users from gaining access. Based on strict polices (i.e. prescribed internet protocol (IP) sources and destinations) the proxy service 668 allows approved source IP addresses through.

The list of attributes is set by the system administrator and provided to them by senior leadership. In general, though, there is a common list that all missions or situations may have. For example, source IP, destination IP, date created, time to live, author or source that generated the data (i.e. radar data), GPS data, classification level, group or list of users allowed to view.

The authorization engine 666 provides an approval (e.g., provides the requested data) or a denial of access to the data to the user that issued the request 670.

The COI admin 344 assigns policy fields based on a goal of the teams 104, 106, or decision maker 108. The policy fields as illustrated include the subject attribute 660, global access policy 662, object attribute 664, or a combination thereof.

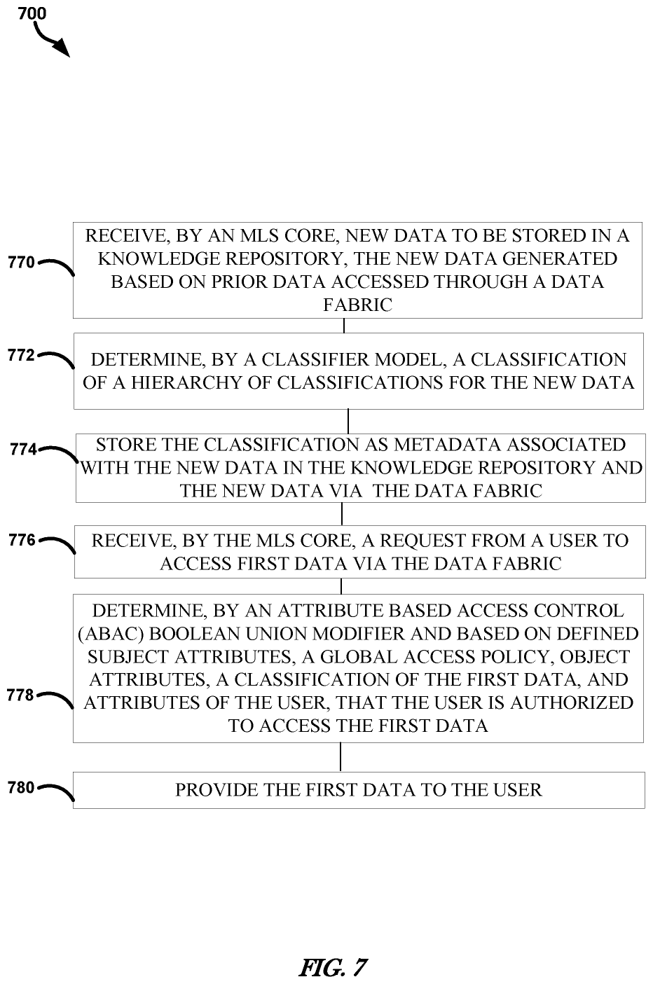

FIG. 7 illustrates, by way of example, a diagram of an embodiment of a method 700 for MLS data collaboration and access. The method 700 as illustrated includes receiving, by an MLS core, new data to be stored in a knowledge repository, the new data generated based on prior data accessed through a data fabric, at operation 770; determining, by a classifier model, a classification of a hierarchy of classifications for the new data, at operation 772; storing the classification as metadata associated with the new data in the knowledge repository and the new data via the data fabric, at operation 774; receiving, by the MLS core, a request from a user to access first data via the data fabric, at operation 776; determining, by an ABAC Boolean union modifier and based on defined subject attributes, a global access policy, object attributes, a classification of the first data, and attributes of the user, that the user is authorized to access the first data, at operation 778; and providing the first data to the user, at operation 780.

The method 700 can further include training the classifier model based on input, output examples that include an actual classification for each input example that includes actual data associated with the actual classification. The method 700 can further include parsing policy definitions and program security classification guidelines for requirements associated with the new data. The method 700 can further include providing a whitelist to the classifier model along with the new data, wherein determining the classification occurs further based on the whitelist.

The method 700 can further include associating, by a certificate authority of the knowledge repository, a certificate for the new data. The method 700 can further include binding, by an integrity binder of the knowledge repository, the certificate to the new data resulting in a bound certificate. The method 700 can further include associating the bound certificate with the new data and storing the bound certificate in the knowledge repository.

The operation 778 can include identifying first that the user satisfies the global access control policy, and then determining that the user satisfies the object attribute policy and the local subject attribute policy. The global access control policy can include coarse grained governance for user and application access at an enterprise level including authorized users, authorized roles, and authorized applications. The object attribute policy can include attributes that are assigned to the file, including classification, data type, location, and an identifier to define the object. The local subject attribute policy can include attributes at a mission level including community of interest (COI), a specific mission, or a time window in which access is allowed.

The method 700 can further include adding context data to the new data before determining the classification. The method 700 can further include determining the classification further based on the context data. The context data can include a goal of the user and others working with the user to accomplish the goal.

AI is a field concerned with developing decision-making systems to perform cognitive tasks that have traditionally required a living actor, such as a person. NNs are computational structures that are loosely modeled on biological neurons. Generally, NNs encode information (e.g., data or decision making) via weighted connections (e.g., synapses) between nodes (e.g., neurons). Modern NNs are foundational to many AI applications, such as classification, device behavior modeling (as in the present application) or the like. The model 452, or other component or operation can include or be implemented using one or more NNs.

Many NNs are represented as matrices of weights (sometimes called parameters) that correspond to the modeled connections. NNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the NN graph-if the threshold is not exceeded then, generally, the value is not transmitted to a down-graph neuron and the synaptic connection remains inactive. The process of weighting and testing continues until an output neuron is reached; the pattern and values of the output neurons constituting the result of the NN processing.

The optimal operation of most NNs relies on accurate weights. However, NN designers do not generally know which weights will work for a given application. NN designers typically choose a number of neuron layers or specific connections between layers including circular connections. A training process may be used to determine appropriate weights by selecting initial weights.

In some examples, initial weights may be randomly selected. Training data is fed into the NN, and results are compared to an objective function that provides an indication of error. The error indication is a measure of how wrong the NN's result is compared to an expected result. This error is then used to correct the weights. Over many iterations, the weights will collectively converge to encode the operational data into the NN. This process may be called an optimization of the objective function (e.g., a cost or loss function), whereby the cost or loss is minimized.

A gradient descent technique is often used to perform objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached—and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used, such as stochastic gradient descent (SGD), Adam, etc.

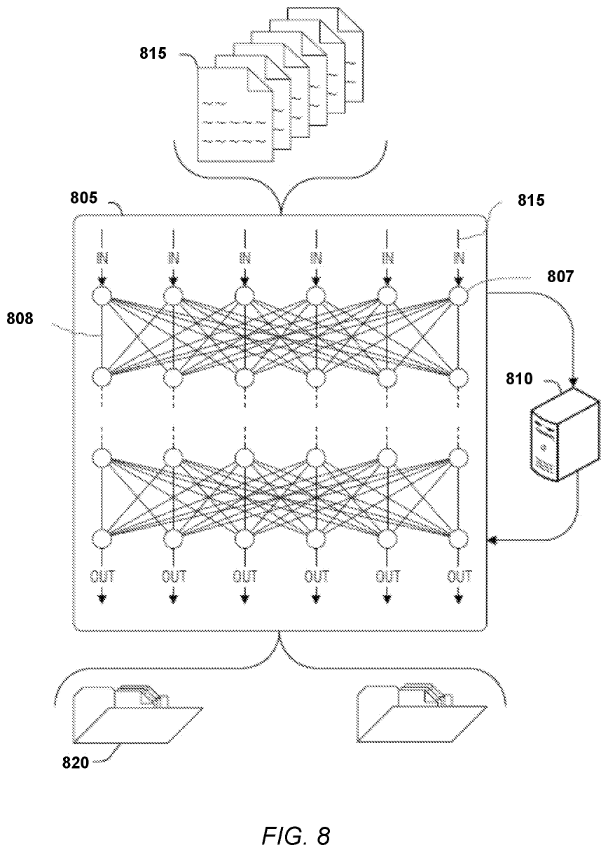

FIG. 8 is a block diagram of an example of an environment including a system for neural network (NN) training. The system includes an artificial NN (ANN) 805 that is trained using a processing node 810. The processing node 810 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the ANN 805, or even different nodes 807 within layers. Thus, a set of processing nodes 810 is arranged to perform the training of the ANN 805. The model 452, or the like, can be trained using the system.

The set of processing nodes 810 is arranged to receive a training set 815 for the ANN 805. The ANN 805 comprises a set of nodes 807 arranged in layers (illustrated as rows of nodes 807) and a set of inter-node weights 808 (e.g., parameters) between nodes in the set of nodes. In an example, the training set 815 is a subset of a complete training set. Here, the subset may enable processing nodes with limited storage resources to participate in training the ANN 805.

The training data may include multiple numerical values representative of a domain, such as an image feature, or the like. Each value of the training or input 815 to be classified after ANN 805 is trained, is provided to a corresponding node 807 in the first layer or input layer of ANN 805. The values propagate through the layers and are changed by the objective function.

As noted, the set of processing nodes is arranged to train the neural network to create a trained neural network. After the ANN is trained, data input into the ANN will produce valid classifications 820 (e.g., the input data 815 will be assigned into categories), for example. The training performed by the set of processing nodes 807 is iterative. In an example, each iteration of the training the ANN 805 is performed independently between layers of the ANN 805. Thus, two distinct layers may be processed in parallel by different members of the set of processing nodes. In an example, different layers of the ANN 805 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 807 (e.g., neurons) are trained independently. In an example, the nodes are trained on different hardware.

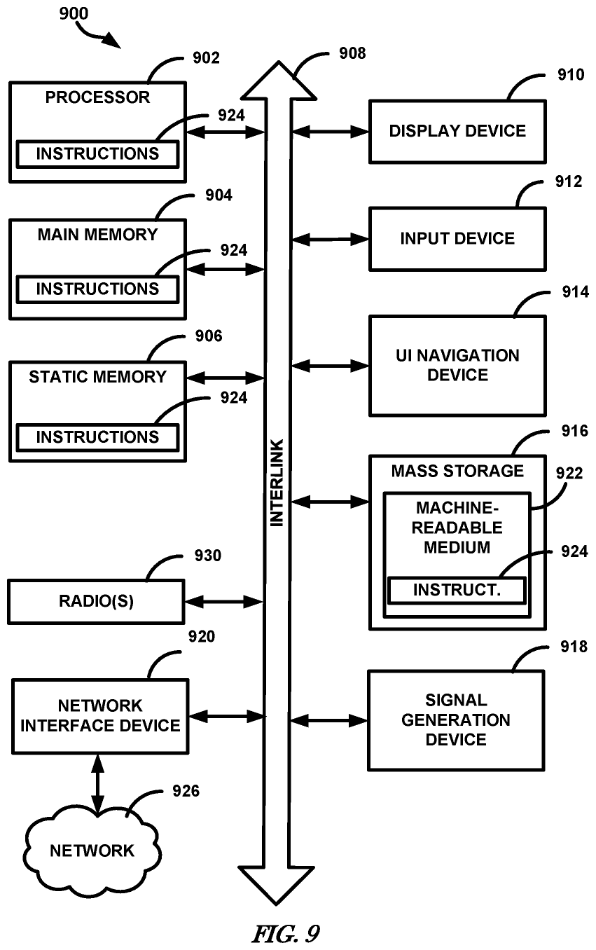

FIG. 9 illustrates, by way of example, a block diagram of an embodiment of a machine in the example form of a computer system 900 within which instructions, for causing the machine to perform any one or more of the methods or techniques discussed herein, may be executed. One or more of the operations 110, MLS services 220, 222, 224, access interface 238, consumer 330, 332, MLS consumer node 334, MLS fabric node 338, MLS data access node 336, MLS core 340, host environment 342, COI administration 344, parser 448, model 452, training operation 454, process 456, automated check 460, operation 464, knowledge repository 352, certificate authority 550, integrity binder 552, policy controller 554, segmented repository 556, authorization engine 666, proxy services 668, ABAC Boolean union modifier 366, method 700, or other component, operation, or technique, can include, or be implemented or performed by one or more of the components of the computer system 900. In a networked deployment, the machine may operate in the capacity of a server or a client machine in server-client network environment, or as a peer machine in a peer-to-peer (or distributed) network environment. The machine may be a personal computer (PC), server, a tablet PC, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a mass storage unit 916, a signal generation device 918 (e.g., a speaker), a network interface device 920, and a radio 930 such as Bluetooth, WWAN, WLAN, and NFC, permitting the application of security controls on such protocols.

The mass storage unit 916 includes a machine-readable medium 922 on which is stored one or more sets of instructions and data structures (e.g., software) 924 embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding, or carrying instructions for execution by the machine and that cause the machine to perform any one or more of the methodologies of the present disclosure, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 924 may further be transmitted or received over a communications network 926 using a transmission medium. The instructions 924 may be transmitted using the network interface device 920 and any one of a number of well-known transfer protocols (e.g., HTTPS). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of encoding, or carrying instructions for execution by the machine, and includes digital or analog communications signals or other intangible media to facilitate communication of such software.

### ADDITIONAL EXAMPLES

Example 1 includes a method for MILS data collaboration and access comprising receiving, by an MILS core, new data to be stored in a knowledge repository, the new data generated based on prior data accessed through a data fabric, determining, by a classifier model, a classification of a hierarchy of classifications for the new data, storing the classification as metadata associated with the new data in the knowledge repository and the new data via the data fabric, receiving, by the MLS core, a request from a user to access first data via the data fabric, determining, by an attribute based access control (ABAC) Boolean union modifier and based on a local subject attribute policy, a global access policy, an object attribute policy, a classification of the first data, and attributes of the user, that the user is authorized to access the first data, and providing the first data to the user.

In Example 2, Example 1 further includes training the classifier model based on input, output examples that include an actual classification for each input example that includes actual data associated with the actual classification.

In Example 3, at least one of Examples 1-2 further includes parsing policy definitions and program security classification guidelines for requirements associated with the new data, and providing a whitelist to the classifier model along with the new data, wherein determining the classification occurs further based on the whitelist.

In Example 4, at least one of Examples 1-3 further includes associating, by a certificate authority of the knowledge repository, a certificate for the new data, binding, by an integrity binder of the knowledge repository, the certificate to the new data resulting in a bound certificate, and associating the bound certificate with the new data and storing the bound certificate in the knowledge repository.

In Example 5, at least one of Examples 1-4 further includes, wherein determining the user is authorized to access the first data includes identifying first that the user satisfies the global access control policy, and then determining that the user satisfies the object attribute policy and the local subject attribute policy.

In Example 6, Example 5 further includes, wherein the global access control policy includes course grained governance for user and application access at an enterprise level including authorized users, authorized roles, and authorized applications, the object attribute policy contains attributes that are assigned to the first data, including classification, data type, location, and an identifier to define the object, and the local subject attribute policy includes attributes at a mission level including community of interest (COI), a specific mission, or a time window in which access is allowed.

In Example 7, at least one of Examples 1-6 further includes adding context data to the new data before determining the classification; and determining the classification further based on the context data.

In Example 8, Example 7 further includes, wherein the context data includes a goal of the user and others working with the user to accomplish the goal.

Example 9 includes a non-transitory machine-readable medium including instructions that, when executed by a machine, cause the machine to perform operations for multi-level secure (MILS) data collaboration and access, the operations comprising the method of one of Examples 1-8.

Example 10 includes a system for multi-level secure (MILS) data collaboration and access, the system configured to perform the method of one of Examples 1-8.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. A method for multi-level security (MLS) data collaboration and access comprising:
receiving, by an MLS core, new data to be stored in a knowledge repository, the new data generated based on prior data accessed through a data fabric;
determining, by a classifier model, a classification of a hierarchy of classifications for the new data;
storing the classification as metadata associated with the new data in the knowledge repository and the new data via the data fabric;
receiving, by the MLS core, a request from a user to access first data via the data fabric;
determining, by an attribute based access control (ABAC) Boolean union modifier and based on a local subject attribute policy, a global access policy, an object attribute policy, a classification of the first data, and attributes of the user, that the user is authorized to access the first data; and
providing the first data to the user.

2. The method of claim 1, further comprising training the classifier model based on input, output examples that include an actual classification for each input example that includes actual data associated with the actual classification.

3. The method of claim 1, further comprising:
parsing policy definitions and program security classification guidelines for requirements associated with the new data; and
providing a whitelist to the classifier model along with the new data, wherein determining the classification occurs further based on the whitelist.

4. The method of claim 1, further comprising:
associating, by a certificate authority of the knowledge repository, a certificate for the new data;
binding, by an integrity binder of the knowledge repository, the certificate to the new data resulting in a bound certificate; and
associating the bound certificate with the new data and storing the bound certificate in the knowledge repository.

5. The method of claim 1, wherein determining the user is authorized to access the first data includes identifying first that the user satisfies the global access control policy, and then determining that the user satisfies the object attribute policy and the local subject attribute policy.

6. The method of claim 5, wherein:
the global access control policy includes course grained governance for user and application access at an enterprise level including authorized users, authorized roles, and authorized applications;
the object attribute policy contains attributes that are assigned to the first data, including classification, data type, location, and an identifier to define the object; and
the local subject attribute policy includes attributes at a mission level including community of interest (COI), a specific mission, or a time window in which access is allowed.

7. The method of claim 1, further comprising:
adding context data to the new data before determining the classification; and
determining the classification further based on the context data.

8. The method of claim 7, wherein the context data includes a goal of the user and others working with the user to accomplish the goal.

9. A non-transitory machine-readable medium including instructions that, when executed by a machine, cause the machine to perform operations for MLS data collaboration and access, the operations comprising:
receiving, by an MLS core, new data to be stored in a knowledge repository, the new data generated based on prior data accessed through a data fabric;
determining, by a classifier model, a classification of a hierarchy of classifications for the new data;
storing the classification as metadata associated with the new data in the knowledge repository and the new data via the data fabric;
receiving, by the MLS core, a request from a user to access first data via the data fabric;
determining, by an attribute based access control (ABAC) Boolean union modifier and based on defined a local subject attribute policy, a global access policy, an object attribute policy, a classification of the first data, and attributes of the user, that the user is authorized to access the first data; and
providing the first data to the user.

10. The non-transitory machine-readable medium of claim 9, wherein the operations further comprise training the classifier model based on input, output examples that include an actual classification for each input example that includes actual data associated with the actual classification.

11. The non-transitory machine-readable medium of claim 9, wherein the operations further comprise:
parsing policy definitions and program security classification guidelines for requirements associated with the new data; and
providing a whitelist to the classifier model along with the new data, wherein determining the classification occurs further based on the whitelist.

12. The non-transitory machine-readable medium of claim 9, wherein the operations further comprise:
associating, by a certificate authority of the knowledge repository, a certificate for the new data;
binding, by an integrity binder of the knowledge repository, the certificate to the new data resulting in a bound certificate; and
associating the bound certificate with the new data and storing the bound certificate in the knowledge repository.

13. The non-transitory machine-readable medium of claim 9, wherein determining the user is authorized to access the first data includes identifying first that the user satisfies the global access control policy, and then determining that the user satisfies the object attribute policy and the local subject attribute policy.

14. The non-transitory machine-readable medium of claim 13, wherein:
the global access control policy includes course grained governance for user and application access at an enterprise level including authorized users, authorized roles, and authorized applications;
the object attribute policy contains attributes that are assigned to the first data, including classification, data type, location, and an identifier to define the object; and
the local subject attribute policy includes attributes at a mission level including community of interest (COI), a specific mission, or a time window in which access is allowed.

15. The non-transitory machine-readable medium of claim 9, wherein the operations further comprise:
adding context data to the new data before determining the classification; and
determining the classification further based on the context data.

16. The non-transitory machine-readable medium of claim 15, wherein the context data includes a goal of the user and others working with the user to accomplish the goal.

17. A system for MLS data collaboration and access, the system comprising:
an MLS core configured to receive new data to be stored in a knowledge repository, the new data generated based on prior data accessed through a data fabric;
a classifier model configured to determine a classification of a hierarchy of classifications for the new data;
a knowledge repository configured to store the classification as metadata associated with the new data;
the MLS core further configured to receive a request from a user to access first data via a data fabric;
an attribute based access control (ABAC) Boolean union modifier configured to determine, based on a local subject attribute policy, a global access policy, an object attribute policy, a classification of the first data, and attributes of the user, that the user is authorized to access the first data; and
wherein the MLS core is configured provide the first data to the user responsive to the ABAC Boolean modifier determining the user is authorized to access the first data.

18. The system of claim 17, wherein the knowledge repository includes:
a certificate authority configured to associate a certificate with the new data; and
an integrity binder configured to bind the certificate to the new data resulting in a bound certificate; and
the knowledge repository is configured to associate the bound certificate with the new data and storing the bound certificate in the knowledge repository.

19. The system of claim 17, wherein determining the user is authorized to access the first data includes identifying first that the user satisfies the global access control policy, and then determining that the user satisfies the object attribute policy and the local subject attribute policy.

20. The system of claim 19, wherein:
the global access control policy includes coarse grained governance for user and application access at an enterprise level including authorized users, authorized roles, and authorized applications;
the object attribute policy contains attributes that are assigned to the first data, including classification, data type, location, and an identifier to define the object; and
the local subject attribute policy includes attributes at a mission level including community of interest (COI), a specific mission, or a time window in which access is allowed.
